(19) United States
(12) Patent Application Publication
(10) Pub. No.: US 2013/0001008 A1
(43) Pub. Date: Jan. 3, 2013

(54) Hearing Protection Device For Removable Mounting to Eyeglass Frames

(75) Inventors: Joseph Corona, Baden, PA (US); Jeffrey Merriman, Hillsboro, OR (US)

(73) Assignee: KPR CONCEPTS, LLC, Hillsboro, OR (US)

(21) Appl. No.: 13/609,324

(22) Filed: Sep. 11, 2012

Related U.S. Application Data
(63) Continuation-in-part of application No. 13/083,579, filed on Apr. 10, 2011.

(51) Int. Cl. G02C 11/06

(52) U.S. Cl. 181/129

(57) ABSTRACT

A configurable hearing protection device capable of attachment to a temple support bar of any pair of eye or safety glasses. The device is a single elongated shaft having a securement loop at one end, an earplug attachment means at a second end, and a plurality of securing nubs disposed in between. The elongated shaft is wrapped around the frame of a pair of glasses and cinched tightly to prevent it from moving around while in use. The securement nubs hold the end of the securement loop in place so that it does not loosen and slip off of the glasses frame. Any suitable earplug may be removably secured to the earplug attachment means. The device is flexible and can be manipulated into a position of the user's choosing.

### CROSS REFERENCE TO RELATED APPLICATION

This application claims the benefit of U.S. Provisional Application No. 61/324,399 filed on Apr. 15, 2010, entitled “Hearing Protection” and U.S. patent application Ser. No. 13/083,579, filed on Apr. 10, 2011 and entitled “Eye Glass Attachable Hearing Protection. These applications are incorporated here by reference in their entirety to provide continuity of disclosure.

### BACKGROUND OF THE INVENTION

1. Field of the Invention

The present invention relates to portable hearing protection devices. More specifically, the present invention relates to a freely positionable hearing protection device that removably secures to the frame of any pair of eye or safety glasses. It provides an easy to use earplug that can be positioned by a user for a customized and comfortable fit within the ear.

2. Background and Description of the Prior Art

In many industrial plants and factories, workers are required to wear safety glasses and/or earplugs in order to protect their eyes from airborne debris and their ears from excessive noise levels. One particularly common and very effective form of earplug consists of a baffled cone-shaped member having a cavity or recess in its posterior end. This cavity allows attachment of the earplug to different devices, most typically to a cord or string. Such earplug and cord assemblies commonly dangle from the user's neck, causing annoyance and creating a risk of injury if the cord becomes entangled in moving machinery parts.

In many work environments, safety glasses and earplugs are not always readily available or kept in a colocated location. It is also easy to misplace or lose an earplug in a cluttered work environment such as a machine shop, factory, or auto mechanics shop. Nevertheless, the Occupational Safety and Health Administration requires that workers wear hearing and eye protection in such environments to protect themselves. A solution is needed that combines hearing and eye protection and requires minimal space for storage.

The present invention is an eyeglass attachable device that allows for the use or storage of earplugs in conjunction with the use of a set of eye or safety glasses. The device attaches directly to eye or safety glasses and can easily be adjusted in placement and positioning. The combination of the hearing protection and eyeglasses facilitates consistent availability, for quick insertion or removal of earplugs. Additionally, the device prevents the earplugs from being carelessly misplaced because the earplugs are suspended from the glasses when not in use.

Earplugs and devices that attach to eye or safety glasses are known in the prior art. Patents have been granted, as well as applications published, for several devices that attempt to address the problems of earplug availability and cleanliness. However, the prior art fails to provide a device fully capable of conveniently assisting with the insertion and removal of earplugs while preventing their loss or contamination. Further, the prior art fails to provide a device that can be bent into a desired position and maintained in that position while the earplugs are in use.

There are numerous devices that provide a cord or other string-type method of attachment. Pyle U.S. Pat. No. 5,475,449 is directed to a string-type device that removably secures a standard set of earplugs to a pair of eyeglasses via a stringy cord. Pule requires, modification of the eyeglass to include a loop portion on the temple support bar for the attachment cord to pass through. Rhoad U.S. Pat. No. 5,806,526 is directed to a pair of earplugs that are removably attached to eye or safety glasses by a cord. The earplugs, which are preferably made of foam or other deformable material, are secured together by a continuous strap for holding or hanging a pair of glasses.

Fleming U.S. Pat. No. 6,082,855 is directed to an attachment for safety eyeglasses that includes a mounting means, an earplug that can fit into the ear canal to block noise, and a string-type coupling that connects the mount to the earplug. The mount includes a tube of elastomeric material that can be stretched over an eyeglass frame temple bar to fix its position and prevent “jiggling”. The coupling includes a wire of resilient plastic that is wound into a tight helix, which allows it to be stored between the rear of the outer ear and the skull to minimize earplug motion when the earplug is not inserted into the ear canal.

All of these devices comprise earplugs attached to a cord or string. Such devices have several disadvantages including their dangling nature, which is distracting for the practitioner and introduces a risk of interference with moving machinery.

Other devices in the prior art disclose combinations of hearing and eye protection. Huhtala U.S. Pat. No. 5,541,677 is directed to a vision-hearing protection device, each embodiment including an eyeglass retainer, for holding eyeglasses on the user's head or around the neck, and earplugs connected to the retainer for protecting the user's hearing. This vision-hearing protection device includes a retraction feature wherein the earplugs may be pulled in for more secure and compact storage and then quickly drawn out toward the ears for convenient reinsertion. Bright U.S. Pat. No. 5,781,272 is directed to an eyesight and hearing safety apparatus that comprises a front guard portion protecting the eyesight of the user, and two earpieces attached to the temple supports for hearing protection.

Sanpei U.S. Pat. No. 6,382,213 is a similar combination device for hearing and sight protection. It is supported on a person's head through contact with both ear canals and rests on the bridge of a person's nose and is readily adjustable. Finally, Wadsworth U.S. Pat. No. 6,728,974 is directed to an eye and ear protection device providing a glasses-like eye shield hingedly attached earplugs disposed on the ends of the ear supports.

The prior art devices have several known drawbacks. The combination of an ear and eye-protection device does not allow practitioners the flexibility to interchange between different pairs or types of eyeglasses, thus limiting the practitioner to those devices produced by the manufacturer. The present invention allows the practitioner to select the most suitable eye protection for their work environment. The present invention is not bound by a set type of eye protection glasses, and indeed may be freely exchanged between multiple pairs of safety glasses, eyeglasses or sunglasses, depending on the requirements or personal preferences of the practitioner.

Additionally, it is well known that ill-fitting or dangling apparel poses a severe risk in certain work environments. Dangling items can become entangled with heavy machinery, subjecting the worker to potential injury or death. The present invention eliminates this risk by removing any loose or dangling articles from its design. Thus, the present invention differs in design elements from the prior art and provides a substantial improvement over known devices.

### SUMMARY OF THE INVENTION

In view of the foregoing disadvantages inherent in the known types of configurable hearing protection devices now present in the prior art, the present invention provides a new device capable of removably securing to the frame of a pair of glasses wherein the same can be utilized for providing convenience for the user when operating in a high noise level environment.

The present invention provides a hearing protection device that can be used on almost any pair of eyeglasses. It is flexible and positionable, making it easy to use with a wide variety of ear types. The device comprises a flexible, elongated shaft with a securement loop at one end and an earplug attachment means at the opposing end. To attach the device to the temple support bar of a pair of eyeglasses, the shaft is bent around the support bar and the earplug attachment means is passed through the securement loop. The elongated shaft is pulled to cinch the device around the temple support bar. A plurality of securing nubs is disposed along the shaft to provide adjustable securement of the device. After cinching the securement loop is positioned between two of the nubs to prevent it from sliding along the elongated shaft while the device is in use. An earplug may then be secured to the earplug attachment means.

An alternative embodiment of the device includes multiple securement loops and no securement nubs. In this embodiment the temple support bar of a pair of eyeglasses will pass through both of the securement loops rather than having the device wrap around the support bar. The embodiment will be useful for eyeglasses with larger frames or safety goggles with temple support bars of relatively uniform width. In such cases, the size of the temple support bar may be too large to permit the elongated shaft to wrap around the bar and the two securement loops can be used for stabilized securement instead of the wrap around means.

Another alternative embodiment of the present invention includes a permanently affixed earplug in place of the earplug attachment means. This version of the device can be washed and used repeatedly without necessitating replacement of an earplug. It offers a hearing protection solution to people who work in environment where they do not have ready access to an earplug replacement supply and cannot carry such items on their person.

The hearing protection device is constructed of a thermoplastic vulcanizate so that the device is flexible and can be bent to a user's desired positioning. Once the device has been manipulated into a desired position, the material will hold the position until a user bends the device again. Thus the device is a single piece of molded material that provides a fully customized fit to users of all ear shapes and sizes.

It is therefore an object of the present invention to provide a configurable hearing protection device having all the advantages of the prior art and none of the disadvantages.

A further object of the present invention is to provide a configurable hearing protection device that is capable of removably securing to the a pair of eye or safety glasses

Another object of the present invention is to provide hearing protection that can be quickly applied and removed without placing the device on dirty or contaminated surfaces in the workplace.

Still another aspect of the present invention is to a configurable hearing protection device that can be manipulated into a customized position that fits an individual user according to his or her needs.

Yet another object of the present invention is to provide a configurable hearing protection device that is durable, lightweight and easy to manufacture.

Other objects, features and advantages of the present invention will become apparent from the following detailed description taken in conjunction with the accompanying drawings.

### BRIEF DESCRIPTIONS OF THE DRAWINGS

FIG. 1 shows an overhead perspective view of the configurable hearing protection device in a ready for use state.

FIG. 2 shows a perspective view of the primary embodiment of the configurable hearing protection device secured to the temple support bar of a pair of eyeglasses.

FIG. 3 shows a side view of the present invention and depicts an example of the flexibility of the device.

FIG. 4 shows a perspective view of an alternative embodiment of the present invention having multiple securement loops, through which the temple support bar of a pair of eyeglasses is threaded.

### DETAILED DESCRIPTION OF THE INVENTION

Reference is made herein to the attached drawings. Like reference numerals are used throughout the drawings to depict like or similar elements of the configurable hearing protection device. For the purposes of presenting a brief and clear description of the present invention, the preferred embodiment will be discussed as used for providing a lightweight, unobtrusive hearing protection solution that can be configured to an individual user's wearing preferences. The figures are intended for representative purposes only and should not be considered to be limiting in any respect.

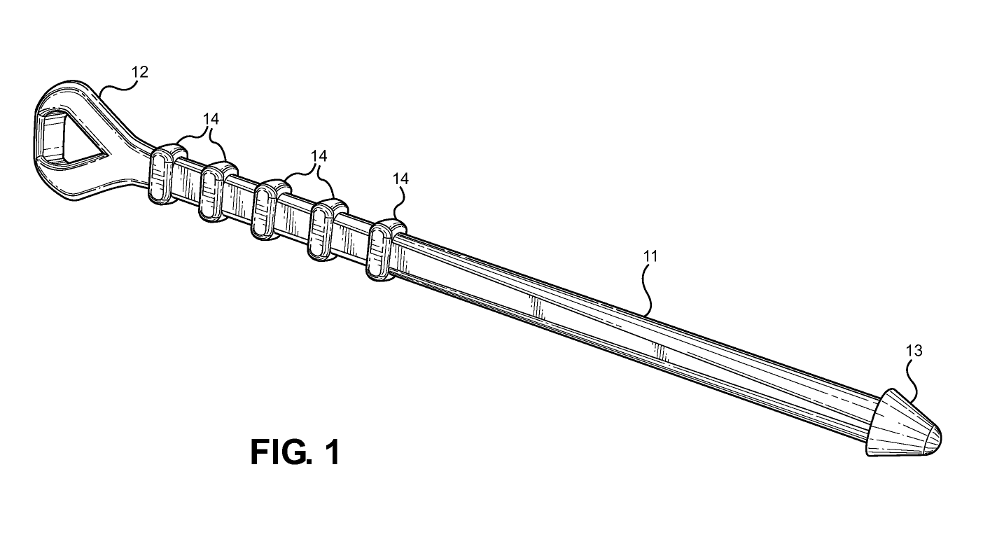

Referring now to FIG. 1, there is shown a perspective view of the primary embodiment of the device, also known as the “wrap-around” embodiment. The configurable hearing protection device comprises an elongated shaft 11 having a securement loop 12 disposed at one end and an earplug attachment means 13. A plurality of nubs 14 is disposed along the length of the elongated shaft, near the securement loop. These nubs are used in combination with the securement loop to removably secure the device to the temple support bar of a pair of eyeglass frames.

The earplug attachment means is a conical, domed, or triangular barb disposed at an end of the elongated shaft. An earplug of any shape and construction can be removably attached to the device by inserting the earplug attachment means into a cavity in the rear of the earplug. Earplug replacements for the device will come with pre-cut cavities in the back of the plug, so that they may be easily secured to the earplug attachment means. Preferably the earplugs will have a rear opening of smaller diameter than the interior cavity. Thus, when the earplug attachment mean sis inserted through the opening and into the cavity, the barbed shape of the attachment means prevents it from easily sliding out of the opening. Earplugs that are foam, plastic, rubber, or any other deformable material that is safe for insertion into the human ear, may be used.

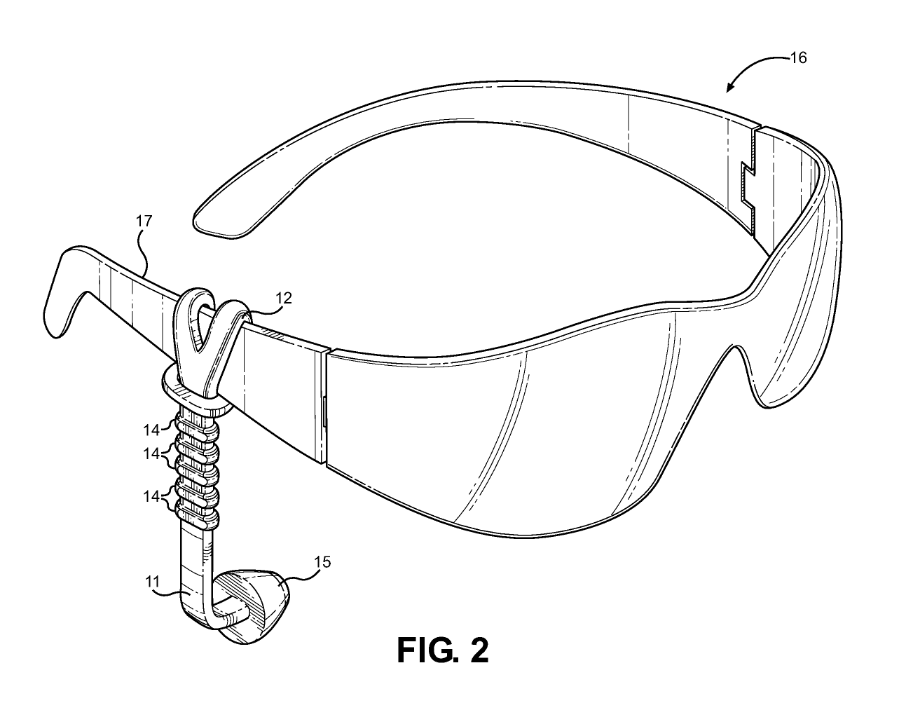

Referring now to FIG. 2, there is shown a view of the wrap-around embodiment of the device secured to the temple support bar 17 of a pair of eyeglass frames 16. The securement loop 12 is wrapped around the temple support bar and passed over the earplug 18, elongated shaft 11, and the plurality of securing nubs 14. The end of the securement loop is cinched until the device is tightly secured to the temple support bar. To help keep the device securely fastened in place, a plurality of securement nubs is disposed near the securement loop. After the device is in place on a temple support bar, the end of the securement loop is positioned above the securement nubs or between two nubs, to prevent the loop from sliding along the elongated shaft while the device is in use. Positioning of the securement loop end within the plurality of securement nubs will depend upon the circumference of the temple support bar. In this way, the device can be adjusted for use with many styles of eye or safety glasses.

The device is shown with a permanently attached earplug 18. The earplug is bent inward towards the frame of the eyeglasses to show how it can be positioned for use. The size and shape of the earplug may vary during manufacture. For example it may have a conical shape as shown, or a more contoured shape to fit within the ear canal. Earplug shape and design is well known in the art of hearing protection and the possible earplug styles that can be used in the construct of the present invention will be readily apparent to one of ordinary skill in the art. In this embodiment the earplug is a part of the hearing protection device and they are constructed as a single unit.

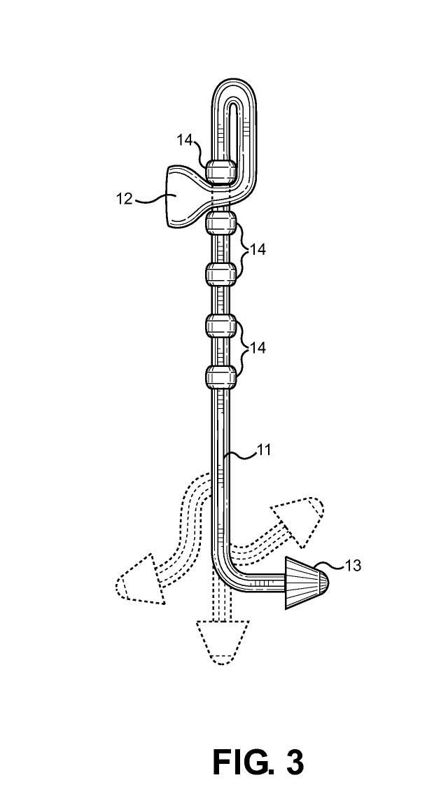

Turning now to FIG. 3 there is shown a side view of the wrap-around embodiment of the device. The securement loop 12 is position in a secured state above the plurality of securing nubs 14 to further illustrate how the device attaches to the frame of a pair of glasses. The upper end of the securement loop need not have the same thickness as the rest of the loop and may be thicker at the top. This increased thickness helps maintain the placement of the loop between the securing nubs so that it does not slip along the elongated shaft 11. The device is flexible and can be bent or manipulated in any direction. The earplug attachment means 13 is shown as manipulable about a given point on the elongated shaft. This movement can be performed along any part of the elongated shaft, allowing a user to bend and form an earplug's angle of entry into his or her ear. The device may be bent in multiple directions or at multiple points. It is this malleability that provides a user with a configurable fit within the ear. The feature is an important distinction over the prior art and will be appreciated by those with large, small, or oddly placed ears.

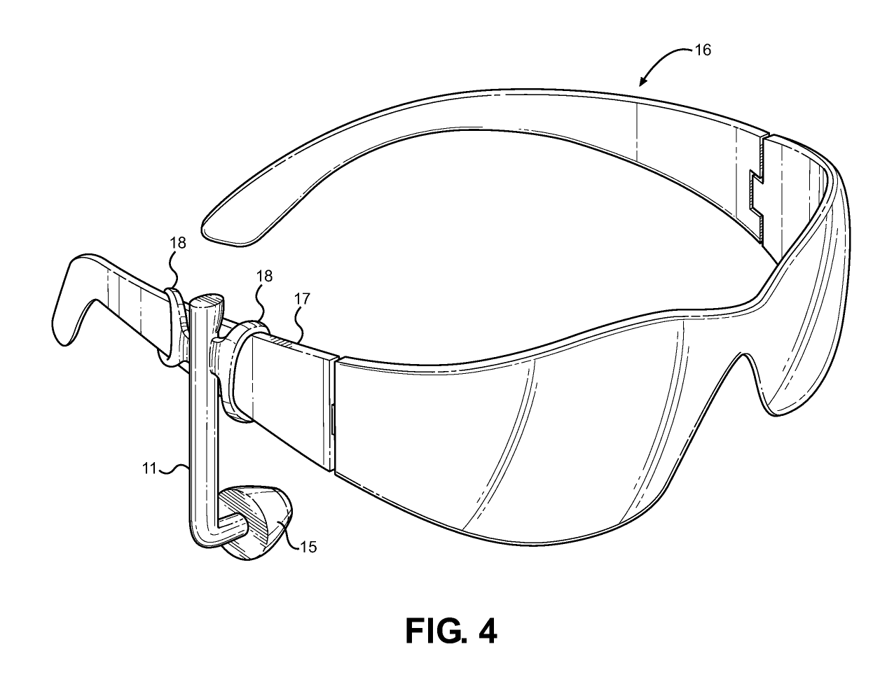

Referring finally to FIG. 4, an alternative embodiment, the “elephant ear” embodiment is shown secured to the temple support bar 17 or a pair of eyeglasses 16. Two securement loops 12 are disposed on either side of an upper end of the elongated shaft 11 and a permanently secured earplug 18 (optional) is secured at a lower end of the shaft. The securement loops of this embodiment are larger in diameter than that of the wrap-around embodiment because they must be sufficiently large to permit a temple support bar to pass through them. Glasses with larger frames such as safety goggles may have temple support bars that are too large to permit the wrap around version to secure around the bar while leaving adequate length left on the elongated shaft for the user to fit the device in his or her ear. The elephant ear embodiment addresses this problem by providing securement loops that the temple support bar can pass through. Because the temple support bar will rest on both loops, the securement loops serve as a stabilizing means to reduce the amount that the device rocks back and forth and moves around. The use of two loops is highly preferable to the use of just one loop due to the lack of stability provided by a single loop that permits a temple support bar to pass therethrough.

In use an individual unfolds a pair of glasses and holds a temple support bar in one hand. Using the other hand, he bends the elongated shaft of the configurable hearing protection device around the temple support bar. Then, the earplug attachment means is inserted through the securement loop and pulled downward until the device is cinched tightly. The upper end of the securement loop is positioned between two securement nubs to hold it in place and prevent the cinched device from loosening. An earplug is then attached to the device by inserting he earplug attachment means into a cavity in the rear of the earplug. Once the device is in a desired position on the frame of the glasses and an earplug is attached, the user places the glasses on his face. The user then bends and manipulates the elongated shaft of the device until the earplug can be comfortably inserted into the user's ear. After user, the earplugs can be gently pulled out of the ear, and the elongated shaft bent outwards to position the earplug away from the ear. The device can remain secured to the glasses frame and readjusted the next time a user desires hearing protection.

The present invention thus provides easily portable and configurable hearing protection that can be used with a wide variety of glasses or safety eyewear. The primary, wrap-around embodiment encircles a temple support bar and cinches tightly in place. It can be used with glasses frames varying from thick to thin, and even elastic bands, like those worn with safety goggles. The securing nubs provide a securable adjustment by preventing the cinch from loosening while the device is in use. Alternatively, the elephant ear embodiment does not require the securing nubs and instead uses two large securing loops to balance the device on a temple support bar. Either embodiment may include a permanently secured earplug or an earplug attachment means for removably securing disposable earplugs.

All embodiments of the device are constructed from a thermoplastic vulcanizate material such as Santoprene. This material is sufficiently flexible to permit the device to be bent and manipulated, and possesses sufficient rigidity to maintain a position after being bent. These qualities make the device adjustable and configurable and also help it hold the configured position while the device is in use, features that are a distinct advantages over floppy ear plug tethers. Thermoplastic vulcanizates are also naturally antibacterial, as well as being electrical insulators. Doctors, electricians and anyone who works in a dirty environment or is exposed to electrical current, will appreciate the construction of the present invention.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A hearing protection device for removable securement to a pair of eyeglasses, comprising:
an elongated shaft;
at least one securement loop disposed at a first end of said elongated shaft'
a plurality of securement nubs disposed along said elongated shaft near said securement loop;
an earplug attachment means disposed at a second end of said elongated shaft.

2. The device of claim 1, wherein said device is bendable.

3. The device of claim 1, wherein said device is constructed of thermoplastic vulcanizate.

4. The device of claim 1, wherein said earplug attachment means is a triangular barb.

5. The device of claim 1, wherein said earplug attachment means is a conical barb.

7. The device of claim 1, wherein there are two of said securement loops.

8. A hearing protection device for removable securement to a pair of eyeglasses, comprising:
an elongated shaft;
at least one securement loop disposed at a first end of said elongated shaft'
an earplug attachment means disposed at a second end of said elongated shaft.

9. The device of claim 8, wherein said device is bendable.

10. The device of claim 8, wherein said device is constructed of thermoplastic vulcanizate.

11. The device of claim 8, wherein said earplug attachment means is a triangular barb.

12. The device of claim 8, wherein said earplug attachment means is a conical barb.

13. The device of claim 8, wherein there are two of said securement loops.

14. A hearing protection device for removable securement to a pair of eyeglasses, comprising:
an elongated shaft;
at least one securement loop disposed at a first end of said elongated shaft'
an earplug disposed at a second end of said elongated shaft.

15. The device of claim 14, further comprising:
a plurality of securement nubs disposed along said elongated shaft near said securement loop;

16. The device of claim 14, wherein said device is bendable.

17. The device of claim 14, wherein said device is constructed of thermoplastic

18. The device of claim 14, wherein there are two of said securement loops.
